(19) United States
(12) Patent Application Publication
(10) Pub. No.: US 2024/0417054 A1
(43) Pub. Date: Dec. 19, 2024

(54) SURVEILLANCE SYSTEM AND METHOD

(71) Applicant: Ford Global Technologies, LLC, Dearborn, MI (US)

(72) Inventors: John Robert Van Wiemeersch, Novi, MI (US); Robert Bruce Kleve, Ann Arbor, MI (US); Brendan Diamond, Grosse Pointe, MI (US); Keith Weston, Canton, MI (US); Stuart C. Salter, White Lake, MI (US)

(73) Assignee: Ford Global Technologies, LLC, Dearborn, MI (US)

(21) Appl. No.: 18/333,542

(22) Filed: Jun. 13, 2023

(51) Int. Cl. B64U 20/87; B64U 10/60; B64U 50/31; B64U 50/32

(52) U.S. Cl. CPC B64B 1/50; B64U 10/60; B64U 80/86; G03B 15/006; G05D 1/678; B64U 2101/31; B64U 2201/10; B64U 2201/202

(57) ABSTRACT

A surveillance system is disclosed. The surveillance system may include a power source, a tether and an unmanned aerial vehicle (UAV). The tether may include tether proximal distal ends. The tether may obtain power from the power source via a tether connection unit connected to the tether distal end. The UAV may be removably attached to the tether proximal end and configured to obtain power from the tether. The UAV may obtain a trigger signal to follow a target object. The UAV may maneuver UAV movement to follow the target object responsive to obtaining the trigger signal. The UAV may additionally determine that a distance between the UAV and the tether connection unit may be equivalent to a tether length when the UAV may be following the target object. The UAV may detach from the tether when the distance may be equivalent to the tether length.

### TECHNICAL FIELD

The present disclosure relates to surveillance systems and methods and more particularly to surveillance systems and methods that use an unmanned aerial vehicle (UAV) to perform surveillance of a geographical area.

### BACKGROUND

Surveillance systems are typically installed to monitor a geographical area, e.g., a parking lot, entry or exit points of buildings, interior or exterior portions of shops, etc. Such systems generally include cameras that capture geographical area images and transmit the images to a remote storage or a control unit. A surveillance operator may monitor the captured images and may cause the surveillance system to output an alert when a malicious user or an unwanted activity may be detected in the geographical area.

Conventional surveillance systems are permanently installed in buildings, shops, etc., and hence provide limited flexibility to the operator to move or temporarily install the systems. For example, if the operator desires to temporarily install a surveillance system at a geographical area hosting an event (e.g., a vehicle rally or a sports event), the conventional surveillance systems may provide limited utility.

There are known moveable surveillance systems that may be installed temporarily at geographical areas. Such moveable surveillance systems may include cameras, on-board power source, and wheels that may enable the systems to be moved from one location to another, thus enabling the operator to conveniently move and install surveillance systems at different locations based on operator requirements. While moveable surveillance systems may provide benefits to the operator, such systems may be expensive and complex to install.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example of an environment in which techniques and structures for providing the systems and methods disclosed herein may be implemented.

FIG. 2 depicts a block diagram of an example of a surveillance system in accordance with the present disclosure.

FIG. 3 depicts an example of a surveillance system with an unmanned aerial vehicle (UAV) nest in accordance with the present disclosure.

FIG. 4A depicts an example of a snapshot of a UAV capturing images of a target object in accordance with the present disclosure.

FIG. 4B depicts an example of a snapshot of a UAV following a target object in accordance with the present disclosure.

FIG. 5 depicts an example of a snapshot of a surveillance system installed on a building in accordance with the present disclosure.

FIG. 6 depicts a flow diagram of an example of a surveillance method in accordance with the present disclosure.

### DETAILED DESCRIPTION

### Overview

The present disclosure describes surveillance systems and methods using an unmanned aerial vehicle (UAV) or drone. The system may be attached to or mounted on a vehicle cargo bed. The system may include a base, one or more solar panel units or renewable energy source units, a battery pack, a tether connection unit, a tether, and a UAV having UAV cameras. The solar panel units, the battery pack, and the tether connection unit may be attached to the base. The battery pack may obtain power from the solar panel unit or vehicle batteries. The battery pack may provide power to the tether connection unit, which may transfer the power to the tether. The tether may connect the tether connection unit with the UAV and may be configured to transfer power from the tether connection unit to the UAV, thus powering the UAV. The UAV may capture images of a geographical area where the surveillance system/vehicle may be located by using the UAV cameras, when the UAV may be powered. The UAV may transmit the captured images to the vehicle or an external server for monitoring and analysis.

In some aspects, the UAV may be configured to fly and capture images of a wide geographical area. The UAV may be connected with the tether when the UAV may be flying. The tether may be extendable, thus enabling the UAV to fly a substantial distance away from the tether connection unit, while still being connected to the tether.

The UAV may be configured to obtain a trigger signal from the vehicle, an internal UAV image processing module, or the external server when a target object (e.g., a malicious user or a target vehicle) may be detected in the geographical area based on the images captured by the UAV cameras. Responsive to obtaining the trigger signal, the UAV may follow the target object and capture target object images, while still being connected to the tether. The UAV may be further configured to determine that the tether may be fully extended when the UAV may be following the target object (and the target object may be moving). Responsive to such determination, the UAV may be configured to detach from the tether and continue to follow the moving target object. The UAV may be powered by on-board UAV battery when the UAV may be detached from the tether. Further, the tether connection unit may include an electric motor that may retract the tether when the UAV may detach from the tether.

In some aspects, the vehicle may also follow the target object when the UAV may be following the target object. In this manner, the vehicle may assist the UAV in capturing the target object images.

In additional aspects, the surveillance system may include a UAV nest that may include a perch on which the UAV may rest when the UAV may not be following the target object or when the UAV may not be flying. The UAV may conserve power required for flying when the UAV may rest on the perch. The UAV nest may further include a telescoping mechanism, which a system operator may adjust to adjust the perch height and/or retract the perch in proximity to the base when the perch may not be required or when the surveillance system or the vehicle may be in transit.

In further aspects, the surveillance system may be configured to be placed or installed on a building or any other similar structure and may not require the vehicle for operation. In this case, the surveillance system may obtain power from solar energy, its own battery pack, building/utility power, or may obtain power via a wireless charging pad or the UAV nest, to enable UAV operation.

The present disclosure is directed to a surveillance system and method. The surveillance system may be conveniently moved and temporarily installed at any geographical location where an operator may desire surveillance. For example, the operator may install the surveillance system on a vehicle, and may move or dispatch the vehicle to any desired location and perform surveillance. Further, since the surveillance system uses a UAV for surveillance, the surveillance is not stationary and is more efficient and secure, as the UAV can easily follow a target object and transmit target object images.

### Illustrative Embodiments

The disclosure will be described more fully hereinafter with reference to the accompanying drawings, in which example embodiments of the disclosure are shown, and not intended to be limiting.

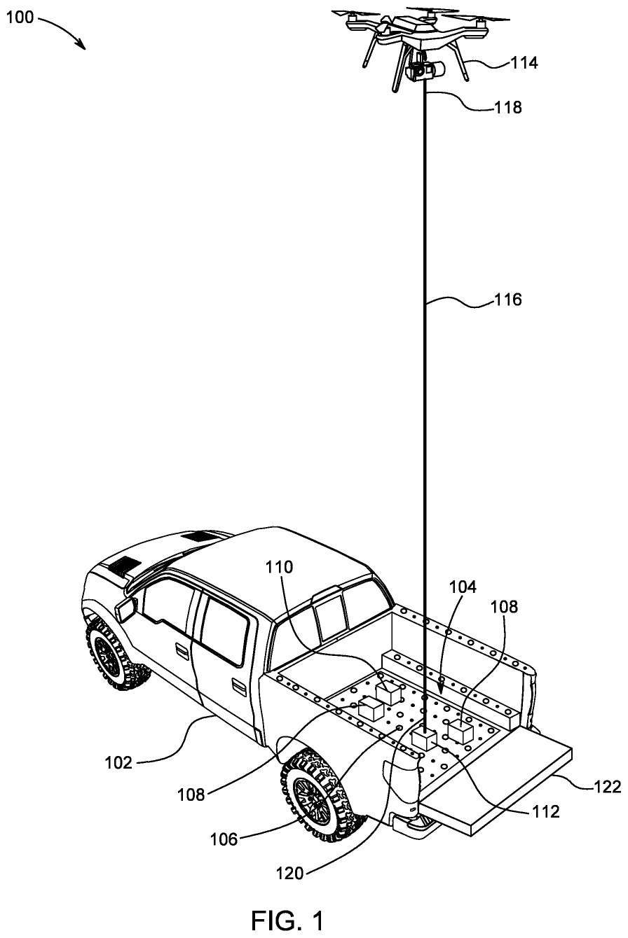

FIG. 1 depicts an example environment 100 in which techniques and structures for providing the systems and methods disclosed herein may be implemented. The environment 100 may include a vehicle 102 that may take the form of any passenger or commercial vehicle such as, for example, an off-road vehicle, a car, a crossover vehicle, a van, a minivan, a bus, a truck, etc. Further, the vehicle 102 may include any powertrain such as, for example, a gasoline engine, one or more electrically-actuated motor(s), a hybrid system, etc. Furthermore, the vehicle 102 may be a manually driven vehicle and/or be configured and/or programmed to operate in a fully autonomous (e.g., driverless) mode (e.g., Level-5 autonomy) or in one or more partial autonomy modes which may include driver assist technologies or remotely operated guidance.

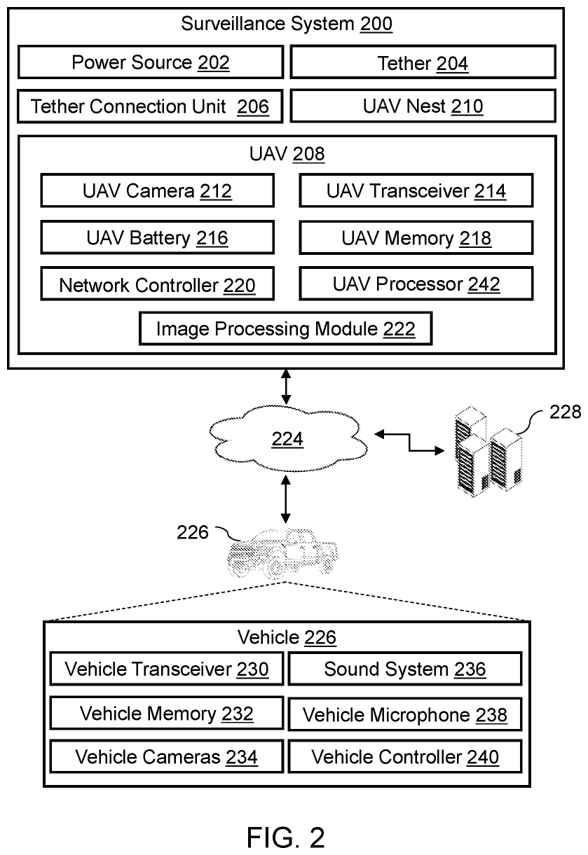

In the exemplary aspect depicted in FIG. 1, the vehicle 102 may be a truck on which a surveillance system (shown as surveillance system 200 in FIG. 2) may be attached or mounted. Specifically, the vehicle 102 may include a cargo bed on which a base 104 of the surveillance system may be attached or mounted. The base 104 may include a matrix of a plurality of attachment connectors or apertures 106 into which a plurality of surveillance system components or units may be “locked” to the base 104. For example, a plurality of surveillance system units such as one or more solar panel cubes or units 108 or other similar renewable power source units, one or more battery packs 110, an unmanned aerial vehicle (UAV) tethering and power delivery unit 112 (hereinafter referred to as a tether connection unit 112), etc. may be locked or attached to the base 104 via the plurality of apertures 106. Collectively, the solar panel unit 108, the battery pack 110 and the tether connection unit 112 may be part of the surveillance system. The surveillance system may further include a drone or a UAV 114 and a tether 116 that may connect the UAV 114 with the tether connection unit 112. The UAV 114 may include one or more on-board UAV cameras (shown as UAV camera 212 in FIG. 2) that may capture images and/or videos of a geographical area in which the vehicle 102 or the surveillance system may be located, or a geographical area in proximity to the UAV 114.

In some aspects, the solar panel units 108 and the battery pack 110 may be connected with each other, such that the solar panel units 108 may transfer energy or power (that the solar panel units 108 may generate using solar energy) to the battery pack 110 for storage purpose. In an exemplary aspect, if the vehicle 102 is a Battery Electric Vehicle (BEV), the battery pack 110 may also receive energy or power from vehicle battery (not shown). Further, the tether connection unit 112 may be connected to the battery pack 110 and may be configured to obtain power from the battery pack 110. The tether connection unit 112 may be further configured to transfer the power obtained from the battery pack 110 to the UAV 114 via the tether 116. Stated another way, the UAV 114 may be configured to receive power from the tether connection unit 112 via the tether 116.

Specifically, the tether 116 may include a tether proximal end 118 and a tether distal end 120. The tether 116 may be connected to the tether connection unit 112 via the tether distal end 120, as shown in FIG. 1. The tether 116 may obtain power from the tether connection unit 112 (i.e., the power that the tether connection unit 112 obtains from the battery pack 110) via the tether distal end 120. The tether 116 may transfer the obtained power to the UAV 114 via the tether proximal end 118.

In some aspects, the UAV 114 may be removably connected or attached to the tether 116 via the tether proximal end 118, which may provide power to the UAV 114. The tether proximal end 118 may include a locking mechanism (not shown) that may enable the tether proximal end 118 to removably attach to the UAV 114. In some aspects, the locking mechanism may be an electromagnetic locking mechanism that may be configured to inductively charge the UAV 114 or transfer power to the UAV 114 via the tether 116.

The UAV 114 may include one or more on-board components or units including, but not limited to, the on-board UAV cameras, a network controller (shown as network controller 220 in FIG. 2), an image processing module (shown as image processing module 222 in FIG. 2), on-board light emitting diode (LED) flood lamps (not shown), on-board infrared illuminators (not shown), and/or the like. The network controller may provide wireless communication capabilities to the UAV 114, and may enable the UAV 114 to transmit images/videos captured by the on-board UAV cameras to a vehicle memory (shown as vehicle memory 232 in FIG. 2) and/or one or more external server(s) via a network (shown as network 224 in FIG. 2). The external server may be associated with a surveillance control room or a surveillance operator who may analyze the images/videos captured by the on-board UAV cameras and determine if a malicious user may be present in the geographical area where the vehicle 102/surveillance system may be located. The surveillance operator may additionally determine if an unwanted activity (e.g., stealing activity, an assault activity, etc.) may be occurring in the geographical area based on the images/videos captured by the on-board UAV cameras. The surveillance operator may transmit a trigger signal, via the external server and the vehicle 102, to the UAV 114 to “follow” the malicious user or a target vehicle (e.g., when the unwanted activity is associated with stealing of a vehicle) when such a target user or an unwanted activity is detected. The surveillance operator may additionally transmit target user or vehicle details, e.g., user images, vehicle license plate number, user/vehicle location information, etc. to the UAV 114 for the UAV 114 to follow the target user.

In some aspects, the “surveillance operator” described above may be a human operator or an Artificial Intelligence (AI)/Machine Learning (ML) based computer algorithm or processor.

Responsive to receiving the trigger signal and target user/vehicle details, the UAV 114 may use the image processing module to locate the target user/vehicle in the geographical area (e.g., by performing pixel analysis of images/videos captured by the on-board UAV camera), and may follow the target user/vehicle to capture target user/vehicle images or videos. In some aspects, the tether 116 may be extendable, and hence the UAV 114 may remain connected to the tether 116 and follow the target user/vehicle, when the target user/vehicle may be moving (e.g., running or driving the target vehicle).

In some aspects, the UAV 114 may be further configured to determine if the tether 116 is fully extended and the target user/vehicle may still be moving. For example, the UAV 114 may determine if a distance between the UAV 114 and the tether connection unit 112 may be equivalent to a maximum tether length, and the UAV 114 may still have to follow the moving target user/vehicle. Responsive to such determination, the UAV 114 may detach itself from the tether 116 and continue to follow the target user/vehicle and capture the target user/vehicle images or record videos. In this case, an on-board UAV battery (shown as UAV battery 216 in FIG. 2) may power the UAV 114, when the UAV 114 may be detached from the tether 116. In this manner, the UAV 114 may capture the target user/vehicle images or record videos even when the target user/vehicle moves away from the geographical area.

The surveillance system, as disclosed here in the present disclosure, is a moveable surveillance system that may be moved from one location to another and may be temporarily installed at any location based on surveillance requirements. For example, if a user desires to temporarily install the surveillance system in a geographical area that may be hosting a sports event, the user may park the vehicle 102 including the surveillance system at a desired location in the geographical area, and perform geographical area surveillance. Post sports event completion, the user may remove the vehicle 102 including the surveillance system from the geographical area. In this manner, the user may easily install (or remove) the surveillance system at (or from) any location based on surveillance requirements. In some aspects, the user may physically install (e.g., park) and/or remove the vehicle 102 from the desired location. In other aspects, the vehicle 102 may be an autonomous vehicle that may itself park at the desired location based on instructions remotely transmitted to the vehicle 102.

Although the description above describes an aspect where the UAV 114 follows the target user/vehicle, in additional aspects, the vehicle 102 too may follow the target user/vehicle based on the trigger signal obtained from the external server, to enable the UAV 114 to conveniently capture the target user/vehicle images. Further, the present disclosure is not limited to the aspect of the UAV 114 obtaining the trigger signal from the external server to follow the target user/vehicle. In some aspects, the UAV 114 may follow the target user/vehicle based on the target user/vehicle details that may be pre-stored in a UAV memory (shown as UAV memory 218 in FIG. 2). In this case, the UAV 114 may follow the target user/vehicle when the image processing module determines that the target user/vehicle may be present in the geographical area where the surveillance system may be located, based on the pixel analysis of the images/videos captured by the UAV camera and the target user/vehicle details that may be pre-stored in the UAV memory. For example, if a vehicle “A” is known to be a stolen vehicle, license plate information of vehicle “A” may be pre-stored in the UAV memory (e.g., by the surveillance operator or authorities/police). When the image processing module determines that the vehicle “A” may be present in the geographical area (e.g., by comparing the stored license plate information with a vehicle license plate information as determined by the pixel analysis of the images/videos captured by the UAV camera), the image processing module may cause the UAV 114 to follow the vehicle “A”.

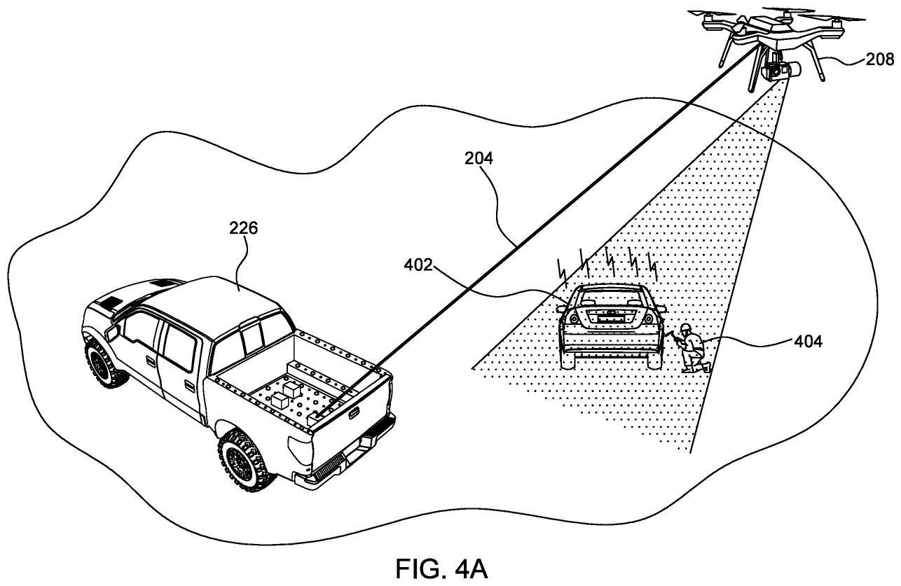

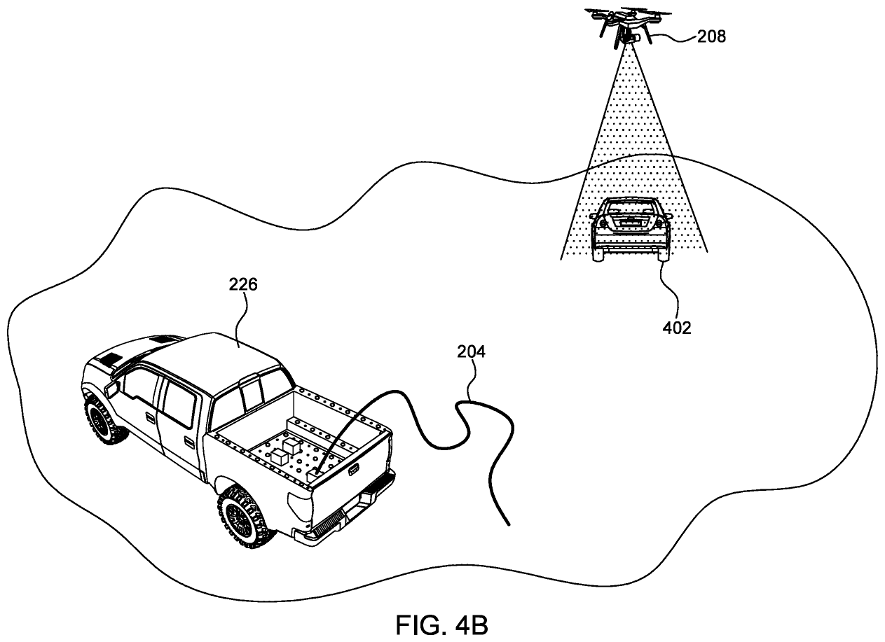

Further, although FIG. 1 depicts an aspect where a vehicle tailgate 122 is in the open state, the surveillance system can operate when the vehicle tailgate 122 is in the closed state as well (as shown in exemplary snapshots of FIGS. 4A and 4B, which are described later in the description below). Stated another way, the surveillance system may operate equally efficiently irrespective of vehicle tailgate close or open state.

The vehicle 102 and the surveillance system may implement and/or perform operations, as described here in the present disclosure, in accordance with the owner manual and safety guidelines.

Further structural and functions details of the surveillance system are described below in conjunction with FIGS. 2-5.

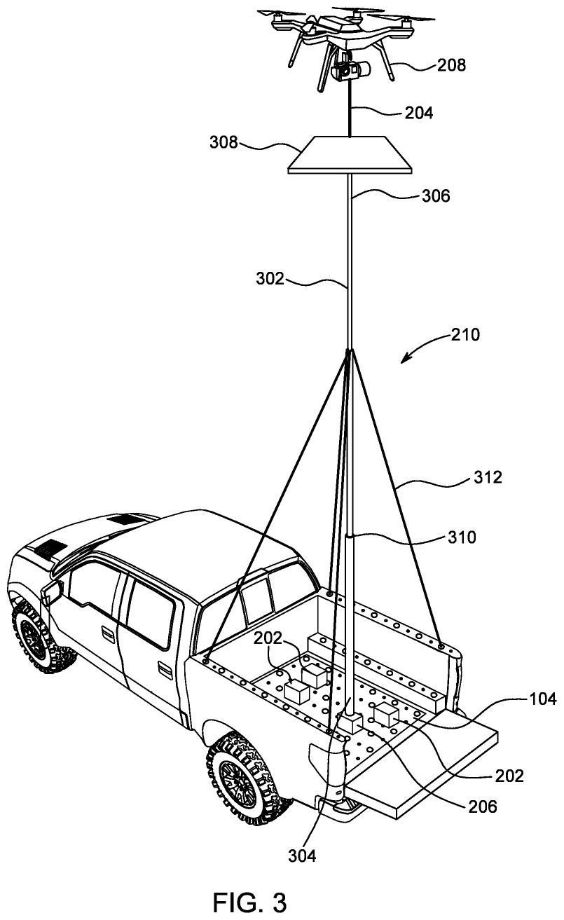

FIG. 2 depicts a block diagram of an example surveillance system 200 in accordance with the present disclosure. The surveillance system 200 may be the same as the surveillance system described in conjunction with FIG. 1. While describing FIG. 2, references may be made to FIGS. 3, 4A and 4B.

The surveillance system 200 may include a power source 202, a tether 204, a tether connection unit 206, a UAV 208 and a UAV nest 210. The power source 202 may be a combination of the solar panel unit 108 and the battery pack 110 described above in conjunction with FIG. 1. The tether 204 may be the same as the tether 116, the tether connection unit 206 may be the same as the tether connection unit 112, and the UAV 208 may be the same as the UAV 114. The UAV nest 210 may be a mechanical structure on which the UAV 208 may “rest” when the UAV 208 may not be following the target user/vehicle. The UAV 208 may reduce power/energy consumption when the UAV 208 may rest on the UAV nest 210, as the power required to enable the UAV 208 to fly may be conserved when the UAV 208 may be resting on the UAV nest 210.

An exemplary snapshot of the surveillance system 200 with the UAV nest 210 is shown in FIG. 3. As shown in FIG. 3, the UAV nest 210 may include an elongated body 302 having a body distal end 304 and a body proximal end 306. The body distal end 304 may be attached to the tether connection unit 206. The UAV nest 210 may further include a perch 308 that may be attached to the body proximal end 306. The perch 308 may be a square or rectangular plate (or circular or any other polygonal-shaped plate) or base on which the UAV 208 may rest when the UAV 208 may not be flying (e.g., when the UAV 208 may not be following the target user/vehicle). The UAV 208 may still capture images/videos of the geographical area where the surveillance system 200 may be located by using on-board UAV camera, when the UAV 208 may be resting on the perch 308.

The perch 308 may include one or more components or units (not shown) that may be attached to or integrated with the perch 308. For example, the perch 308 may include solar panels to provide power energy or power to the battery pack 110 or to the UAV 208, perch cameras disposed at a perch underbelly to capture images/videos of a geographical area in proximity to the perch 308, perch lights on the perch underbelly, and/or the like.

In some aspects, the UAV nest 210 may further include a telescoping mechanism 310 disposed on the elongated body 302, which a system user may adjust elongated body height based on surveillance requirements. For example, the user may increase the elongated body height when the user may desire the UAV 208 to capture images/videos of a large geographical area, and may decrease or lower the elongated body height when the user may desire the UAV 208 to capture images/videos of a relatively smaller geographical area, when the UAV 208 may be resting on the perch 308. The user may further completely retract the elongated body height when the user may not desire to use the UAV nest 210, or when the vehicle 226 may be in transit.

The UAV nest 210 may further include one or more ropes 312 (or cables, chains, and/or the like) that may connect the base 104 (or a portion of the base 104) with the elongated body 302. For example, the ropes 312 may connect the base 104 with an elongated body center portion or any other portion on the elongated body 302. The ropes 312 may provide support and structural integrity to the UAV nest 210, so that the UAV nest 210 may withstand difference forces (e.g., gravitation force, force of winds, etc.) that may be exerted on the UAV nest 210 when the surveillance system 200 may be installed or located in the geographical area. The present disclosure is not limited to the usage of ropes. Cables, chains or similar connecting means may be used instead of ropes without departing from the scope of the present disclosure.

The UAV 208 may include one or more components or units including, but not limited to, a UAV processor 242, one or more UAV cameras 212 (or a UAV camera 212), a UAV transceiver 214, a UAV battery 216, a UAV memory 218, a network controller 220 and an image processing module 222.

The UAV processor 242 may be disposed in communication with one or more memory devices (e.g., the UAV memory 218 and/or one or more external databases not shown in FIG. 2). The UAV processor 242 may utilize the UAV memory 218 to store programs in code and/or to store data for performing aspects in accordance with the disclosure. The UAV memory 218 may be a non-transitory computer-readable memory storing a surveillance program code. The UAV memory 218 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM)), etc.

The UAV camera 212 may be configured to capture 360-degree images/videos of a geographical area in proximity to the UAV 208 or where the UAV 208 may be located. The UAV camera 212 may be an RGB camera and/or a Near Infrared camera (NIR camera). The UAV camera 212 may be a 1920 by 1080 resolution camera or one of higher resolution. The UAV transceiver 214 may be configured to transmit/receive signals, data, images/videos, information, etc. to/from one or more external devices or storage via one or more network(s) 224.

The network(s) 224 illustrates an example communication infrastructure in which the connected devices discussed in various embodiments of this disclosure may communicate. The network(s) 224 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, Ultra-Wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The UAV battery 216 may be configured to store energy or power that the UAV 208 may obtain from the tether 204, as described above in conjunction with FIG. 1. The UAV 208 may use the power stored in the UAV battery 216 when the UAV 208 may be detached from the tether 204 and following the target user/vehicle.

The network controller 220 may be configured to provide wireless communication capabilities to the UAV 208. The network controller 220 may be further configured to provide wireless network or accessibility to the network 224 to a plurality of user devices that may be located in the geographical area where the surveillance system 200 may be disposed. Specifically, the network controller 220 may act as a “mobile hotspot” and may enable the plurality of user devices to access the network 224 via the network controller 220.

The image processing module 222 may be an Artificial Intelligence (AI)/Machine Learning (ML) based module configured to perform pixel analysis of real-time images/videos captured by the UAV camera 212 and determine whether a predefined condition may be met based on the pixel analysis. In an exemplary aspect, the predefined condition may be met when the target user/vehicle may be detected in the real-time images/videos captured by the UAV camera 212. In this case, the UAV memory 218 may pre-store target user/vehicle details (e.g., target user images, vehicle license plate information, etc.) that the UAV 208 may have obtained from one or more external servers or authorities (e.g., police). In the exemplary aspect described here, the target user may be a repeat offender or a user with history of malicious activities, and the target vehicle may be a stolen vehicle.

The image processing module 222 may obtain the pre-stored target user/vehicle details from the UAV memory 218 and compare the pre-stored target user/vehicle details with details of one or more users or vehicles that may be present in the real-time images/videos captured by the UAV camera 212 (as identified via pixel analysis). The image processing module 222 may generate a first trigger signal and transmit the first trigger signal to the UAV processor 242 to cause the UAV 208 to follow the target user/vehicle, when the image processing module 222 detects that the target user/vehicle may be present in the real-time images/videos captured by the UAV camera 212, based on the comparison. The aspect of the UAV 208 following the target user/vehicle is described later in the description below.

In some aspects, the surveillance system 200 may be connected with a vehicle 226 and/or one or more server(s) 228 via the network 224. The server 228 may be associated with a surveillance operator or a surveillance control room. The server 228 may obtain the real-time images/videos captured by the UAV camera 212 directly from the UAV transceiver 214 and the network 224, or via the vehicle 226. The surveillance operator may analyze the real-time images/videos and may detect target user/vehicle presence in the real-time images/videos based on the analysis. Responsive to detecting the target user/vehicle presence in the real-time images/videos, the surveillance operator may cause the server 228 to generate a second trigger signal and transmit the second trigger signal to the UAV transceiver 214 directly via the network 224, or via the vehicle 226, to cause the UAV 208 to follow the target user/vehicle.

The vehicle 226 may be same as the vehicle 102 and may include one or more components and units including, but not limited to, a vehicle transceiver 230, a vehicle memory 232, vehicle cameras 234, a sound system 236, a vehicle microphone 238 and a vehicle network controller or a vehicle controller 240. The vehicle transceiver 230 may be configured to receive/transmit data, signals, information, images/videos, etc. from/to external devices such as the UAV 208 and/or the server 228 via the network 224.

The vehicle cameras 234 may be externally facing vehicle cameras that may be configured to capture images/videos of a geographical area in proximity to the vehicle 226. The vehicle memory 232 may be configured to store data, signals, information, images/videos, etc. received by the vehicle transceiver 230 and/or images/videos captured by the vehicle cameras 234. The sound system 236 may be configured to output audio or alarm based on command or trigger signals received by the vehicle transceiver 230 from the UAV 208 and/or the server 228. The vehicle microphone 238 may be configured to capture sound signals in proximity to the vehicle 226, and transmit the sound signals to the vehicle memory 232 for storage purpose or to the UAV 208 and/or the server 228 via the vehicle transceiver 230. The vehicle controller 240 may be configured to provide wireless network or accessibility to the network 224 to the UAV 208. For example, the UAV 208 may leverage vehicle Wi-Fi via the vehicle controller 240 (and the network controller 220).

In operation, the UAV transceiver 214 may receive the second trigger signal from the server 228 when the server operator may detect the target user/vehicle or an unwanted activity in the geographical area where in the UAV 208 may be located, based on the real-time images/videos obtained by the server 228 from the UAV camera 212. In some aspects, the UAV transceiver 214 may receive the second trigger signal directly from the server 228 via the network 224. In other aspects, the server 228 may send the second trigger signal to the vehicle transceiver 230 via the network 224, and the vehicle transceiver 230 may transmit the second trigger signal to the UAV transceiver 214. Responsive to receiving the second trigger signal, the UAV transceiver 214 may send the second trigger signal to the UAV processor 242.

In additional aspects, the UAV processor 242 may obtain the first trigger signal from the image processing module 222 when the image processing module 222 detects that the target user/vehicle may be present in the real-time images/videos captured by the UAV camera 212, as described above.

Responsive to obtaining the first trigger signal or the second trigger signal, the UAV processor 242 may cause the UAV 208 to lift from the perch 308 (when the UAV 208 may be resting on the perch 308), and maneuver UAV movement to follow the target user/vehicle and capture target user/vehicle images. When the UAV 208 may not be resting on the perch 308 and flying in air, the UAV processor 242 may directly maneuver UAV movement to follow the target user/vehicle and capture target user/vehicle images. An exemplary snapshot of the UAV 208 capturing target user/vehicle images is shown in FIG. 4A.

As shown in FIG. 4A, the UAV 208 may move close to a target vehicle 402 and/or a target user 404 to capture the target user/vehicle images, responsive to obtaining the first/second trigger signal. In some aspects, the tether connection unit 206 may include a tether roll that may extend tether length when the UAV 208 follows the target vehicle 402 and/or the target user 404. For example, the UAV 208 may “pull” the tether 204 from the tether roll when the UAV 208 may require to move away from the tether connection unit 206 to follow the target vehicle 402 and/or the target user 404. In this manner, the UAV 208 may travel a substantial distance away from the tether connection unit 206 (and hence the vehicle 226) to follow the target vehicle 402 and/or the target user 404, while still being attached to the tether 204.

In some aspects, the vehicle 226 too may move closer to the target vehicle 402 and/or the target user 404 to enable the UAV 208 to follow the target vehicle 402 and/or the target user 404 and capture the target user/vehicle images (e.g., when the UAV battery 216 may have power lower than a predefined threshold). In this case, if the vehicle 226 is a manually driven vehicle and/or configured and/or programmed to operate in one or more partial autonomy modes, a vehicle operator (not shown) may move the vehicle 226 closer to the target vehicle 402 and/or the target user 404. If the vehicle 226 is a fully autonomous (e.g., driverless) vehicle, the UAV 208 and/or the server 228 may send a command signal to the vehicle 226 to cause the vehicle 226 to move closer to the target vehicle 402 and/or the target user 404. Vehicle and UAV movements may sync to ensure that the vehicle 226 and the UAV 208 stay together when the UAV 208 may be following the target vehicle 402 and/or the target user 404.

In other aspects, the vehicle 226 may be stationary and may not move closer to the target vehicle 402 and/or the target user 404. In this case, only the UAV 208 may follow the target vehicle 402 and/or the target user 404.

The UAV 208 may capture the target user/vehicle images via the UAV camera 212 when the UAV 208 may be following the target vehicle 402 and/or the target user 404, and may transmit the captured images to the vehicle transceiver 230 via the UAV transceiver 214 and the network 224. In some aspects, the UAV 208 may also transfer images to the vehicle 226 via the tether 204. In additional aspects, the vehicle 226 may also capture the target user/vehicle images and/or images of a geographical area in proximity to the target vehicle 402 and/or the target user 404 via the vehicle cameras 234. The vehicle 226 may store the target user/vehicle images obtained from the UAV 208 (and the images captured by the vehicle cameras 234) in the vehicle memory 232. The vehicle 226 may further transmit the stored target user/vehicle images to the server 228 and/or to an additional server (not shown) associated with authorities (e.g., police) for record purposes, via the vehicle transceiver 230 and the network 224. In alternative aspects, the UAV 208 may directly transmit the target user/vehicle images to the server 228 and/or to the additional server, without routing the images via the vehicle 226.

In additional aspects, the vehicle microphone 238 may capture sound signals originating from the geographical area in proximity to the target vehicle 402 and/or the target user 404, when the vehicle 226 receives the target user/vehicle images from the UAV 208. In this case, the vehicle 226 may store the captured sound signals in the vehicle memory 232, and may transmit the sound signals to the server 228 and/or the additional server for record purposes. In yet another aspect, the vehicle 226 may activate the sound system 236 when the vehicle 226 receives the target user/vehicle images from the UAV 208, or when the UAV 208 receives the first trigger signal or the second trigger signal as described above. In the latter case, the UAV 208 may send a command signal to the vehicle transceiver 230 via the UAV transceiver 214 and the network 224, when the UAV 208 receives the first or the second trigger signal. The vehicle 226 may activate the sound system 236 responsive to obtaining the command signal from the UAV 208, thus alerting and indicating users in proximity to the vehicle 226 about the presence of the target vehicle 402 and/or the target user 404.

In yet another aspect, the UAV 208 and/or the vehicle 226 may be wirelessly connected with a sound system or a flashlight system (not shown) of a store or a parking lot (if the surveillance system 200 is installed in proximity to the store or the parking lot), and may activate the store/parking lot sound system and/or flashlight system when the UAV 208 may be following the target vehicle 402 and/or the target user 404. The UAV 208 and/or the vehicle 226 may additionally (or alternatively) activate their respective flashlight or LED systems (not shown), when the UAV 208 may be following the target vehicle 402 and/or the target user 404.

In further aspects, when the UAV 208 may be following the target vehicle 402 and/or the target user 404, the UAV processor 242 may be configured to determine if the tether 204 may be fully extended from the tether roll and may not be extended further. Stated another way, the UAV processor 242 may be configured to determine that a distance between the UAV 208 and the tether connection unit 206 may be equivalent to a maximum tether length, when the UAV 208 may be following the target vehicle 402 and/or the target user 404. The UAV processor 242 may be further configured to determine that the target vehicle 402 and/or the target user 404 may be moving further away from the UAV 208 and the UAV 208 may be required to continue to follow the target vehicle 402 and/or the target user 404.

Responsive to determining that the tether 204 may be fully extended and the target vehicle 402 and/or the target user 404 may be moving further away from the UAV 208, the UAV processor 242 may cause the UAV 208 to detach from the tether 204 and follow the target vehicle 402 and/or the target user 404. In this case, the UAV processor 242 may unlock the electromagnetic locking mechanism (described above in conjunction with FIG. 1) disposed at the tether proximal end 118 to enable the UAV 208 to detach from the tether 204, responsive to detecting that the tether 204 may be fully extended.

Although the description above describes an aspect where the UAV processor 242 causes the UAV 208 to detach from the tether 204, in alternative aspects, the vehicle 226 may determine that the tether 204 may be fully extended. In this case, the vehicle 226 may cause the electromagnetic locking mechanism to unlock (e.g., by sending/transmitting an unlock command signal to the electromagnetic locking mechanism via the vehicle transceiver 230), thereby detaching the tether 204 from the UAV 208.

In some aspects, the tether connection unit 206 may further include an electric motor (not shown) that may automatically retract the tether 204 back into the tether roll, when the UAV 208 detaches from the tether 204.

In some aspects, the UAV processor 242 may cause the UAV 208 to detach from the tether 204 when the UAV battery 216 may have stored energy greater than a predefined energy threshold. If the UAV processor 242 determines that the UAV battery 216 may have stored energy less than the predefined energy threshold, the UAV processor 242 may not cause the UAV 208 to detach from the tether 204, till an override command signal may be obtained from the vehicle 226 or the server 228. In this case, the surveillance operator may transmit the override command signal to the UAV transceiver 214, via the server 228 directly or via the vehicle 226, when the surveillance operator desires the UAV 208 to follow the target vehicle 402 and/or the target user 404 even if the UAV battery 216 may have low stored energy.

An exemplary snapshot of the UAV 208 following the target vehicle 402 is shown in FIG. 4B. As shown in FIG. 4B, the UAV 208 may detach from the tether 204 when the target vehicle 402 may be moving away. The UAV 208 may continue to capture the target vehicle images (or record videos) and store the captured images in the UAV memory 218, and/or transmit the target vehicle images to the vehicle 226 or the server 228 (when the UAV 208 may have access to the network 224), when the UAV 208 may be following the target vehicle 402. In some aspects, the UAV 208 may additionally transmit UAV geolocation to the vehicle 226 or the server 228 via a UAV Global Positioning System (GPS) receiver (not shown) for record purposes, when the UAV 208 may be following the target vehicle 402.

The UAV 208 may use the image processing module 222 and license plate information of the target vehicle 402 (that may be provided by the server 228 or the vehicle 226, or may be pre-stored in the UAV memory 218) to “lock” onto the target vehicle 402, and continue to follow the target vehicle 402 when the target vehicle 402 may be moving. In additional aspects, the UAV 208 may use the UAV camera 212 and the image processing module 222 to capture and identify additional vehicle details, when the UAV 208 may be following the target vehicle 402. The additional vehicle details may include, for example, vehicle model, vehicle model year, make, and/or the like. The UAV 208 may store the additional vehicle details in the UAV memory 218, and/or transmit the additional vehicle details to the vehicle 226, the server 228 and/or the server associated with authorities (e.g., police) via the UAV transceiver 214 and the network 224 for record purposes.

When the UAV 208 may have finished following the target vehicle 402, the UAV 208 may return to the base 104 and rest in proximity to the tether connection unit 206. In an exemplary aspect, the UAV 208 may return to the base 104 when the UAV battery 216 may have battery power lower than a predefined threshold, or when the UAV transceiver 214 receives a return command signal from the vehicle 226 or the server 228, or when the UAV 208 travels a distance which may be a maximum permissible distance that the UAV 208 may fly in the detached state. The vehicle 226 may determine that the UAV 208 may have returned to the base 104 based on inputs received from the vehicle cameras 234. Responsive to determining that the UAV 208 may have returned to the base 104, the vehicle 226 may cause the electromagnetic locking mechanism to re-attach or re-lock with the UAV 208, thereby causing the tether 204 to re-attach to the UAV 208. The UAV 208 may get powered or energized again and may store power in the UAV battery 216, when the UAV 208 may be re-attached with the tether 204.

In some aspects, the vehicle 226 may further include an enclosure (not shown) that may be powered, may be removably attached to the base 104, and may be configured to house and secure the UAV 208 when the UAV 208 may charging or getting energized, or when the UAV 208 (or the vehicle 226) may be transported.

In further aspects, when the vehicle 226 leaves a surveillance site (e.g., when the vehicle 226 may be moved from one surveillance site to another), the UAV 208 may fly into a vehicle interior portion (e.g., into the enclosure described above) and the UAV nest 210 may completely retract by using the telescoping mechanism 310, thereby enabling efficient vehicle movement.

The surveillance system 200 may include additional components or units, or may perform additional operations that are not depicted in FIGS. 2, 3, 4A and 4B and/or described above. For example, in an exemplary aspect, the surveillance system 200 may additionally or alternatively (e.g., as an alternative to the UAV 208) include a balloon and a balloon tether. The balloon tether may have a balloon tether proximal end and a balloon tether distal end. The balloon tether distal end may be connected to the tether connection unit 206 and the balloon tether proximal end may be connected to the balloon.

The balloon may include a balloon camera configured to capture images/videos of a geographical area where the balloon may be located. The balloon tether may provide power to the balloon camera, or the balloon camera may be battery operated. In the latter case, the balloon tether may not be required to transfer power to the balloon camera.

When the surveillance system 200 includes both the UAV 208 and the balloon, the balloon tether and the tether 204 may be on the same “tether reel”. In this case, a balloon tether roll may be disposed below the tether roll described above, so that when the tether 204 extends or retracts, the tether 204 may not interrupt the balloon tether and the balloon may continue to fly even if the UAV 208 moves and follows the target user 404/vehicle 402. Such an arrangement of the balloon tether roll and the tether roll may also enable the tether 204 to be efficiently managed when the tether 204 may be retracted into the tether roll by the electric motor when the UAV 208 may be detached from the tether 204. For example, instead of the tether 204 being dropped on ground when the UAV 208 may detach from the tether 204, the balloon tether may “hold” the tether 204 above the ground when the electric motor may be retracting the tether 204, thus enabling efficient retraction of the tether 204. In an additional aspect, the tether 204 may also retract and roll inside the UAV body, so that the tether 204 may not drop on the ground.

In further aspects, the balloon may act as an antenna when the network controller 220 may provide accessibility to the network 224 (e.g., Wi Fi, Cellular, UWB, Bluetooth, etc.) to a plurality of user devices in proximity to the balloon or the UAV 208 (e.g., in a parking lot or a construction site). Stated another way, the balloon and the UAV 208 may act as “mobile hotspot” to enable the plurality of user devices in proximity to the balloon or the UAV 208 to access the network 224. In this manner, the surveillance system 200 may assist in geo-fencing, asset tracking, or proving network accessibility to user devices that may not have access to the network 224.

In additional aspects, when the UAV 208 may be following the target vehicle 402 and/or the target user 404, the UAV 208 may perform invasive fly pattern if the target user 404 attempts to attack the UAV 208.

In yet another aspect, the UAV 208 may include a suction cup or an electromagnetic attachment device that may attach to the target vehicle 402 when the UAV 208 may be following the target vehicle 402. In this case, the UAV 208 may save power or energy required for flying, by attaching itself to the target vehicle 402 via the suction cup or the electromagnetic attachment device. The UAV 208 may fly or become airborne again when the target vehicle 402 may stop moving or when a target vehicle door may open.

In further aspects, the vehicle 226 (with the surveillance system 200) may patrol the geographical area where the surveillance operator may desire surveillance, and may thus enable surveillance of a wide-area region. In some aspects, the vehicle 226 may patrol the wide-area region in a predetermined pattern. In other aspects, the vehicle 226 may patrol the wide-area region when an unwanted activity (e.g., a gunshot) may be detected in a specific portion of the wide-area region. In yet another aspect, the vehicle 226 may reposition based on density of vehicles in a parking lot (e.g., if the vehicle 226 is disposed in the parking lot). In this case, the vehicle 226 may reposition to a location in the parking lot where the density of parked vehicles may be greater than a threshold density.

Furthermore, although FIGS. 2, 3, 4A, 4B, depicts an aspect where the vehicle 226 includes a single UAV 208, in other aspects, the vehicle 226 may be attached to more than one UAV, thus enabling the vehicle 226 to track/monitor multiple vehicles in a parking lot at the same time, or simultaneously monitor different locations of the wide-area region. In this case, the vehicle 226 may automatically determine if the vehicle 226 needs to deploy additional UAVs, based on density of vehicles entering or exiting the parking lot, or a count of activities detected in the wide-area region over a predefined time duration. The vehicle 226 may be further configured to remove images/videos from the vehicle memory 232 when the UAVs transmit the captured images/videos to the vehicle 226, and no motion or activity may be detected in the captured images/videos. In this manner, the vehicle 226 may save storage in the vehicle memory 232, when the vehicle 226 may be attached to a plurality of UAVs. When the vehicle 226 may be performing surveillance of a store or a shop, the vehicle 226 may selectively remove those images/videos from the vehicle memory 232 in which the customers may be detected exiting the store with less count of shopping items or items of low value (as detected by the vehicle cameras 234 and/or the UAV camera 212).

In some aspects, the vehicle 226 may deploy or retract one or more UAVs of the plurality of UAVs based on respective charge or battery storage level of UAVs.

In additional aspects, the vehicle 226 (including the surveillance system 200) may be deployed in a park, a home or community to chase unwanted animals, e.g., geese, duck, etc. away. In this case, the UAV 208 may chase the unwanted animals away, when the unwanted animals may enter park, community, or home periphery.

In further aspects, the vehicle 226 (including the surveillance system 200) may be used to perform infrastructure inspection. For example, the vehicle 226 may travel (either automatically or driven manually) to each overpass along a highway stretch, and the UAV 208 may capture close-up views/images of bridge structure and transmit the images to the vehicle 226 or the server 228 for inspection purposes. The UAV 208 may return to the vehicle 226 when the images may be captured, and the vehicle 226 may then move to another overpass on the highway stretch for inspection. The vehicle 226 (including the surveillance system 200) may similarly assist in inspection of dams, power or telephone lines, etc.

The vehicle 226 (including the surveillance system 200) may additionally assist in worksite monitoring or inspection. For example, the vehicle 226 may be deployed at a worksite, and the UAV 208 may assist in monitoring and identifying locations of tools, equipment, machines, workers, etc. on the worksite based on images captured by the UAV camera 212. In some aspects, the UAV 208 may be additionally equipped with magnets or “claws” at a UAV bottom portion, which may assist in transporting tools between the vehicle 226 and the workers on the worksite, based on inputs provided by the surveillance operator.

In yet another aspect, if the vehicle 226 (including the surveillance system 200) is deployed at a store or shop, the surveillance system 200 may be enabled to identify “repeat shoppers” based on images of repeat shoppers that may be pre-stored in the UAV memory 218 or transmitted to the UAV 208 from the server 228. In this case, responsive to identifying a repeat shopper based on the images captured by the UAV camera 212 and by using the image processing module 222, the UAV processor 242 may transmit (via the UAV transceiver 214, the vehicle 226 or the server 228) a pre-stored message to a user device associated with the repeat shopper. In this case, contact details of the user device associated with the repeat shopper may be pre-stored in the UAV memory 218, the vehicle memory 232, and/or the server 228. The pre-stored message may include, for example, a thank you message, a targeted coupon, a discount voucher, and/or the like. Further, in this case, the UAV 208 may not monitor the repeat shoppers for unwanted activity, and may instead monitor other users in store vicinity to detect any unwanted activity.

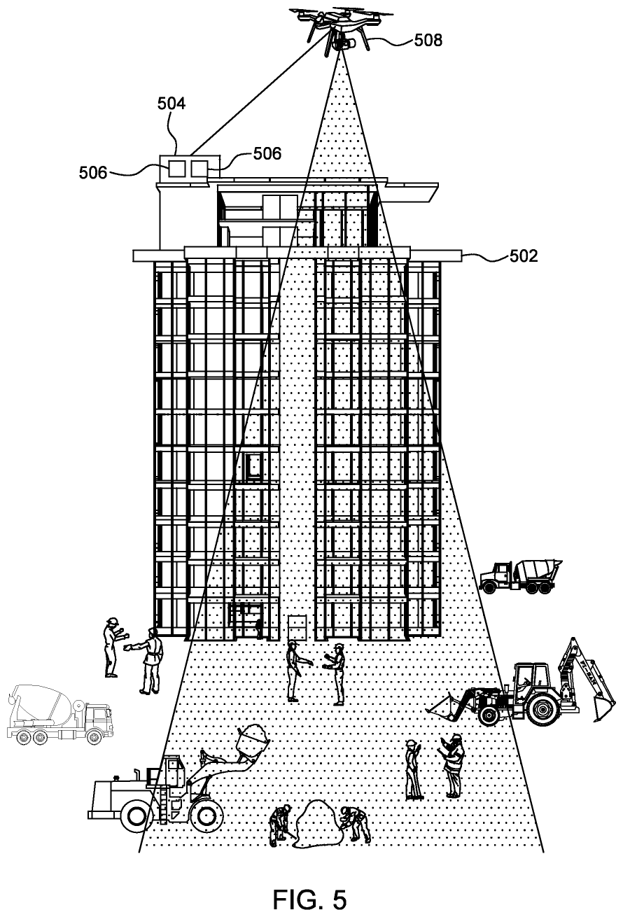

Although the description above describes an aspect where the surveillance system 200 is attached to or mounted on the vehicle 226, the present disclosure is not limited to the surveillance system 200 being mounted on the vehicle 226. An exemplary aspect of the surveillance system 200 without the vehicle 226 is depicted in FIG. 5 and described below.

FIG. 5 depicts an example snapshot of a surveillance system installed on a building 502 (which may be an under-construction building), in accordance with the present disclosure. The surveillance system depicted in FIG. 5 may be same as the surveillance system 200, and may include a base 504, a power source and tether connection unit 506, and a UAV 508. The base 504 may be same as the base 104 and may be mounted on a building top portion (or any other building portion), as shown in FIG. 5. In this case, the base 504 may not be mounted on the vehicle 226, and the surveillance system of FIG. 5 may not require the vehicle 226 for operation.

The power source and tether connection unit 506 may be same as the power source 202 and the tether connection unit 206. Further, the UAV 508 may be same as the UAV 208. In the aspect depicted in FIG. 5, the UAV 208 may monitor and capture images of a geographical area in proximity to the building 502, thereby assisting the surveillance operator to monitor tools, personnel or workers, equipment, machinery, etc. that may be located in or near the building 502.

In the aspect depicted in FIG. 5, the power source and tether connection unit 506 may obtain power from solar energy. In a scenario where the power source and tether connection unit 506 may not obtain power from solar energy (or may not obtain enough solar energy), the UAV 508 may fly only intermittently. In this case, the UAV 508 may fly at a predefined frequency (e.g., every 30 minutes) or may fly when an unwanted activity or a target user may be detected in proximity to the building 502, or when a vehicle may enter or exit building premises or periphery.

In further aspects, the power source and tether connection unit 506 may obtain power from building energy source or utility power, or may obtain power via a wireless charging pad or the UAV nest 210. In this case, the UAV 508 may fly more frequently (e.g., every 5 minutes) or may continuously fly for a preset time duration (e.g., three, five, or seven hours).

The remaining components or units and their respective functionalities are same as the components or units of the surveillance system 200, and hence are not described again here for the sake of simplicity and conciseness.

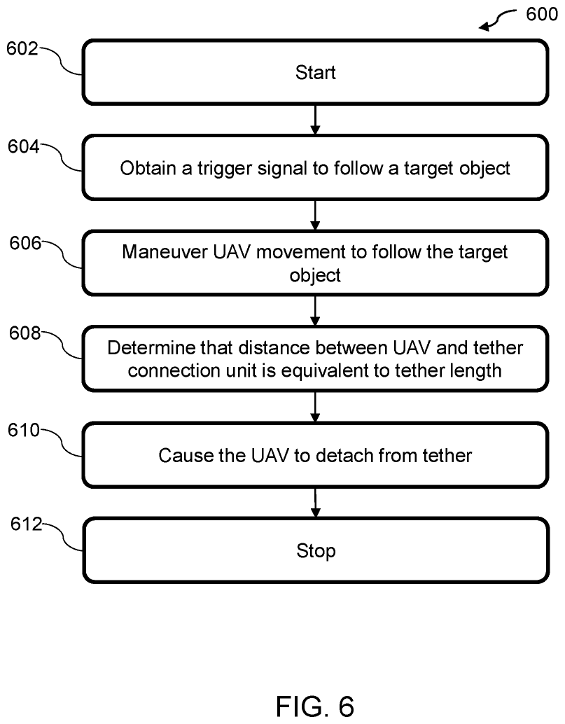

FIG. 6 depicts a flow diagram of an example surveillance method 600 in accordance with the present disclosure. FIG. 6 may be described with continued reference to prior figures, including FIGS. 1-5. The following process is exemplary and not confined to the steps described hereafter. Moreover, alternative embodiments may include more or less steps that are shown or described herein and may include these steps in a different order than the order described in the following example embodiments.

Referring to FIG. 6, at step 602, the method 600 may commence. At step 604, the method 600 may include obtaining, by the UAV processor 242, the first trigger signal or the second trigger signal to follow a target object (e.g., the target user/vehicle). As described above, the UAV processor 242 may obtain the first trigger signal from the image processing module 222, and the second trigger signal from the server 228 or the vehicle 226.

At step 606, the method 600 may include maneuvering, by the UAV processor 242, UAV movement to follow the target object responsive to obtaining the first trigger signal or the second trigger signal. At step 608, the method 600 may include determining, by the UAV processor 242, that a distance between the UAV 208 and the tether connection unit 206 may be equivalent to the maximum tether length. Responsive to such determination, at step 610, the method 600 may include causing, by the UAV processor 242, the UAV 208 to detach from the tether 204 as described above.

The method 600 stops at step 612.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A surveillance system comprising:
a power source;
a tether having a tether proximal end and a tether distal end, wherein the tether is configured to obtain power from the power source via a tether connection unit connected to the tether distal end; and
an unmanned aerial vehicle (UAV) removably attached to the tether proximal end, wherein the UAV is configured to obtain power from the tether, and wherein the UAV comprises a processor configured to:
obtain a trigger signal to follow a target object;
maneuver UAV movement to follow the target object responsive to obtaining the trigger signal;
determine that a distance between the UAV and the tether connection unit is equivalent to a tether length when the UAV is following the target object; and
cause the UAV to detach from the tether when the distance between the UAV and the tether connection unit is equivalent to the tether length.

2. The surveillance system of claim 1, wherein the surveillance system is mounted on a vehicle.

3. The surveillance system of claim 1, wherein the surveillance system is mounted on a building.

4. The surveillance system of claim 1, wherein the power source comprises a solar panel and a battery pack.

5. The surveillance system of claim 1, wherein the tether connection unit is connected with the power source, and wherein the tether connection unit is configured to transfer power from the power source to the tether.

6. The surveillance system of claim 1, wherein the UAV further comprises:
a camera configured to capture images of a geographical area in proximity to the UAV;
an image processing module configured to perform pixel analysis of the images; and
a transceiver configured to transmit the images to an external storage.

7. The surveillance system of claim 6, wherein the image processing module generates the trigger signal when the image processing module determines that a predefined condition is met based on the pixel analysis, and wherein the processor obtains the trigger signal from the image processing module.

8. The surveillance system of claim 1, wherein the processor obtain the trigger signal from a server.

9. The surveillance system of claim 1 further comprising a UAV nest comprising:
an elongated body having a body proximal end and a body distal end, wherein the body distal end is connected to the tether connection unit; and
a perch connected to the body proximal end, wherein the UAV is configured to rest on the perch.

10. The surveillance system of claim 9, wherein the UAV nest further comprises a telescoping mechanism configured to enable a user to adjust an elongated body length.

11. The surveillance system of claim 1 further comprising:
a balloon; and
a balloon tether having a balloon tether proximal end and a balloon tether distal end, wherein the balloon is connected with the balloon tether via the balloon tether proximal end, and wherein the balloon tether distal end is connected to the tether connection unit.

12. The surveillance system of claim 1, wherein the UAV further comprises a network controller configured to provide wireless network to a plurality of user devices.

13. The surveillance system of claim 1, wherein the tether connection unit comprises an electric motor configured to retract the tether when the UAV detaches from the tether.

14. The surveillance system of claim 1 further comprising a base, wherein the power source and the tether connection unit are attached to the base.

15. A surveillance method comprising:
obtaining, by a processor of an unmanned aerial vehicle (UAV), a trigger signal to follow a target object, wherein:
the UAV is removably attached to a tether proximal end of a tether,
the UAV is configured to obtain power from the tether,
a tether distal end of the tether is connected to a tether connection unit, and
the tether is configured to obtain the power from a power source via the tether connection unit;
maneuvering, by the processor, UAV movement to follow the target object responsive to obtaining the trigger signal;
determining, by the processor, that a distance between the UAV and the tether connection unit is equivalent to a tether length when the UAV is following the target object; and
causing, by the processor, the UAV to detach from the tether when the distance between the UAV and the tether connection unit is equivalent to the tether length.

16. The surveillance method of claim 15, wherein the tether connection unit is connected with the power source, and wherein the tether connection unit is configured to transfer power from the power source to the tether.

17. The surveillance method of claim 15, wherein obtaining the trigger signal comprising obtaining the trigger signal from a server.

18. The surveillance method of claim 15 further comprising:
capturing images of a geographical area in proximity to the UAV via a UAV camera;
performing pixel analysis of the images by a UAV image processing module; and
transmitting the images to an external storage.

19. The surveillance method of claim 18 further comprising:
determining, by the UAV image processing module, that a predefined condition is met based on the pixel analysis; and
generating, by the UAV image processing module, the trigger signal when the predefined condition is met, wherein obtaining the trigger signal comprises obtaining the trigger signal from the UAV image processing module.

20. A non-transitory computer-readable storage medium having instructions stored thereupon which, when executed by a processor of an unmanned aerial vehicle (UAV), cause the processor to:
obtain a trigger signal to follow a target object, wherein:
the UAV is removably attached to a tether proximal end of a tether,
the UAV is configured to obtain power from the tether,
a tether distal end of the tether is connected to a tether connection unit, and
the tether is configured to obtain the power from a power source via the tether connection unit;
maneuver UAV movement to follow the target object responsive to obtaining the trigger signal;
determine that a distance between the UAV and the tether connection unit is equivalent to a tether length when the UAV is following the target object; and
cause the UAV to detach from the tether when the distance between the UAV and the tether connection unit is equivalent to the tether length.
